(19) United States
(12) Patent Application Publication
(10) Pub. No.: US 2010/0059556 A1
(43) Pub. Date: Mar. 11, 2010

(54) AIR DISCHARGE VALVE ASSEMBLY FOR CLOTHING COMPRESSING-AND-STORING BAG

(76) Inventor: Myung-Soo KIM, Seoul (KR)

Correspondence Address: LADAS & PARRY LLP, 26 WEST 61ST STREET, NEW YORK, NY, 10023, US

(21) Appl. No.: 12/325,349

(22) Filed: Dec. 1, 2008

(30) Foreign Application Priority Data
Sep. 10, 2008 (KR) 10-2008-0089121

(51) Int. Cl. A41D 27/22; F16K 31/44

(52) U.S. Cl. 223/85; 251/231

(57) ABSTRACT

Disclosed herein is an air discharge valve assembly for discharging air from the interior of a compressing-and-storing bag to compress and store an item. A main body and a cover of an air discharge valve are mounted to the upper and lower portions of a vacuum storage bag, and a lever is inserted into an internal space and moved up and down to be in close contact with a packing installed between the main body and the cover, thus opening or closing an air passage. The air discharge valve assembly includes the air discharge valve, a hanger assembly and a hanger holding unit. The air discharge valve maximizes sealing ability because of improvements in the structure of the packing and the lever. The hanger assembly includes a hanger body which is rotatably coupled to hanger support parts provided on the upper portion of the main body and a hanger hook rotatably assembled with the hanger body. The hanger holding unit having hanger holding holes is rotatably coupled to the lower portion of the main body.

### BACKGROUND OF THE INVENTION

1. Field of the Invention

The present invention relates generally to an air discharge valve assembly for discharging air from the interior of a compressing-and-storing bag to compress and store an item and, more particularly, to an air discharge valve assembly for a clothing compressing-and-storing bag which smoothly discharges air from the compressing-and-storing bag and effectively prevents the entry of external air into the bag due to air-tightness, thus improving the efficiency of use, efficiently preventing the entry of moisture or mold into the bag, and enabling convenient storage of the bag by hanging it as one hangs a hanger.

2. Description of the Related Art

Generally, a compressing-and-storing bag has been used to compress and store bedding or the like after it has been put into the bag and air is discharged therefrom.

Since such a compressing-and-storing bag minimizes the volume of bedding, the compressing-and-storing bag makes it easy to store and carry the bedding and in addition keeps out moisture or mold, thus effectively storing and managing the bedding.

The compressing-and-storing bag may compress and store items of clothing as well as bedding.

That is, the compressing-and-storing bag includes a bag body which is made of a synthetic resin sheet and receives bedding, clothing or other items, and an air discharge valve which is attached to the bag body and is used to discharge the air from the bag.

Thus, after the bedding or clothing is put into the compressing-and-storing bag and the opening is closed, the air is drawn and discharged through the air discharge valve by means of a vacuum cleaner or another evacuation device. Thus, the bedding or clothing in the compressing-and-storing bag is compressed into a reduced volume.

The air discharge valve is the most important part of the compressing-and-storing bag. The present inventor has filed a number of Korean patent and utility model applications regarding air discharge valves for compressing-and-storing bags.

Korean Utility Model Registration No. 20-414999 discloses an air discharge valve as shown in FIG. 1. The air discharge valve includes a main body 3 attached to a vacuum storage bag 2, a support plate 4 coupled to the upper portion of the main body 3 and a lever 6 fitted into an internal space 5 between the main body 3 and the support plate 4. The lever 6 is vertically moved to open or close an air passage formed in the main body 3. The main body 3 has along the inner circumference thereof an annular bottom groove 3a and a contact protrusion 3b. An O-ring 7 coupled to the lower portion of the lever 6 is inserted into the annular bottom groove 3a and thus is in close contact with the annular bottom groove 3a and the contact protrusion 3b, thereby providing an airtight sealing structure.

In this air discharge valve, while the lever 6 is moved up and down, the air passage is opened or closed. When the O-ring 7 of the lever 6 is inserted into the annular bottom groove 3a of the main body 3, the sidewall and bottom wall of the O-ring 7 are brought into air-tight contact with the annular bottom groove 3a and the contact protrusion 3b.

In the air discharge valve set forth above, however, the O-ring 7 is in frictional contact with the annular bottom groove 3a of the main body 3 as the O-ring 7 is moved up and down together with the lever 6. For this reason, the O-ring 7 may be separated from the lever 6, which in turn may destroy the air-tightness.

In an effort to overcome such a problem, Korean Patent No. 10-684669 discloses an air discharge valve as shown in FIG. 2. The air discharge valve includes a main body 3 attached to a vacuum storage bag 2, a support plate 4 coupled to the upper portion of the main body 3, and a lever 6 fitted into an internal space 5 between the main body 3 and the support plate 4. The lever 6 is vertically moved to open or close an air passage formed in the main body 3. A packing-receiving groove 3-1 is formed in the circumference of the inner portion of the main body 3 so that a packing 8 is inserted into the packing-receiving groove 3-1. The inside and outside portions of the upper end of the packing 8 are in close contact with a support protrusion 4-1 of the support plate 4 and a stepped contact surface 6-1 of the lever 6 to provide an air-tight sealing structure.

In this air discharge valve, as the lever 6 is moved up and down, the air passage is opened or closed. The stepped contact surface 6-1 of the lever 6 is in close contact with the inside portion of the packing 8 which is supported between the packing-receiving groove 3-1 of the main body 3 and the support protrusion 4-1 of the support plate 4 to provide an air-tight operation.

In the air discharge valve noted above, however, the support protrusion 4-1 of the support plate 4 protrudes into the internal space 5. Such a construction obstructs the flow of air in the internal space 5, thus reducing the operability of the air discharge valve.

In addition, with the air discharge valves filed by the present inventor, all of the vertical guide structure of the lever 6 provided at the center of the support plate 4 and the air flow passage are exposed to the outside. Thus, the air discharge valve suffers from a reduction in air-tightness. The air discharge valve has another problem in that foreign materials or moisture may be introduced into the air passage.

Further, all the compressing-and-storing bags which were previously filed by the present inventor are used to store bedding, clothing or the like. Especially in the case of storing clothing, it is difficult to store it neatly such that it does not lean to one side in the bag, and it is difficult to conveniently store the compressing-and-storing bag in the same way as one does clothing.

### SUMMARY OF THE INVENTION

Accordingly, the present invention has been made keeping in mind the above problems occurring in the prior art, and an object of the present invention is to provide an air discharge valve assembly for a clothing compressing-and-storing bag which improves the assembly structure of a main body, a cover, a lever and a packing, thus allowing air to be smoothly discharged from the compression-and-storing bag and effectively preventing the entry of external air into the bag by virtue of being air-tight, therefore improving the efficiency of use, and efficiently preventing the entry of moisture or mold into the bag.

Another object of the present invention is to provide an air discharge valve assembly for a clothing compressing-and-storing bag which allows a plurality of garments to be effectively stored in the compression-and-storing bag by hanging the garments in the form of being hung on a coat hanger, and allows the compression-and-storing bag to be conveniently stored by hanging it in the form of a coat hanger.

In order to accomplish the above objects, the present invention provides an air discharge valve assembly for a clothing compressing-and-storing bag constructed so that a main body and a cover are mounted to the upper and lower portions of a vacuum storage bag, and a lever is inserted into an internal space and moved up and down so as to be in close contact with a packing installed between the main body and the cover, thus opening or closing an air passage.

The packing having on its upper portion contact parts which protrude inwards and outwards is inserted into the upper portion of the main body.

The upper and lower portions of the outer contact part of the packing are pressed against and come in close contact with the lower support surface of the cover and the upper support surface of the main body, and a horizontal support surface and a vertical support surface provided on the upper portion and the inside portion of the contact part are in close contact with a horizontal contact surface and a vertical contact surface of a stepped contact groove formed along the circumference of the lower portion of the lever.

Pressure protrusions protrude downwards from the lower support surface of the cover and the horizontal contact surface of the lever.

A plug for closing a guide hole and the air passage formed in the center of the cover is mounted to the upper portion of the lever.

In the present invention, a plurality of air inlet holes is radially formed in the upper portion of the cover, so that external air is introduced into the air inlet holes during the suction operation using a suction nozzle of a vacuum cleaner.

The air discharge valve assembly further includes a hanger assembly used to hang and store the clothing compressing-and-storing bag in a form of a coat hanger. The hanger assembly includes hanger support parts provided on opposite sides of the upper portion of the main body in such a way as to protrude upwards, a hanger body elastically fitted over the hanger support parts in such a way as to rotate forwards and backwards, and a hanger hook having an insert rod which is rotatably inserted into an assembly hole formed in the center of the upper portion of the hanger body.

A groove is formed in each of the hanger support parts of the main body to have a small thickness along part of the outer circumference of the upper portion of the assembly hole, and each of the assembly parts of the hanger body includes a “U”-shaped body and locking pieces which are provided on opposite sides of the body and elastically inserted into the assembly hole of each of the hanger support parts, thus preventing removal of the hanger body from the hanger support parts.

A locking step is provided on the insert rod which is provided on the lower end of the hanger hook, and an elastic support part is provided in the assembly hole of the hanger body and divided by a plurality of division grooves which are arranged along a circumference of the assembly hole, thus preventing the locking step of the insert rod from being removed from the assembly hole.

An assembly hole is formed in the center of the lower portion of the main body so that an insert rod provided on the upper portion of a hanger holding unit having a hanger holding hole is rotatably inserted into the assembly hole, and a locking step is provided on the insert rod, and an elastic support part is provided in the assembly hole of the main body and divided by a plurality of division grooves which are arranged along the circumference of the assembly hole, thus preventing the locking step of the insert rod from being removed from the assembly hole.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view illustrating a conventional air discharge valve which was previously filed by the present inventor;

FIG. 2 is a sectional view illustrating another conventional air discharge valve which was previously filed by the present inventor;

FIG. 3 is a perspective view illustrating an air discharge valve assembly for a clothing compressing-and-storing bag according to the present invention;

FIG. 4 is a sectional view illustrating the air discharge valve assembly for the clothing compressing-and-storing bag according to the present invention;

FIG. 5 is an exploded sectional view illustrating the air discharge valve assembly for the clothing compressing-and-storing bag according to the present invention;

FIG. 6 is an exploded sectional view illustrating an air discharge valve according to the present invention;

FIG. 7 is a bottom view illustrating a hanger body according to the present invention;

FIG. 8 is a bottom view illustrating a main body according to the present invention;

FIGS. 9a to 9c are enlarged sectional views illustrating the important coupled parts according to the present invention; and

FIGS. 10 to 12 are views illustrating the use of the air discharge valve assembly according to the present invention.

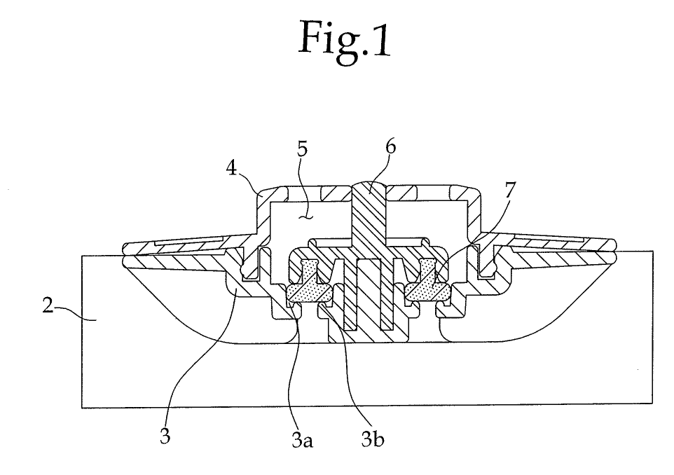

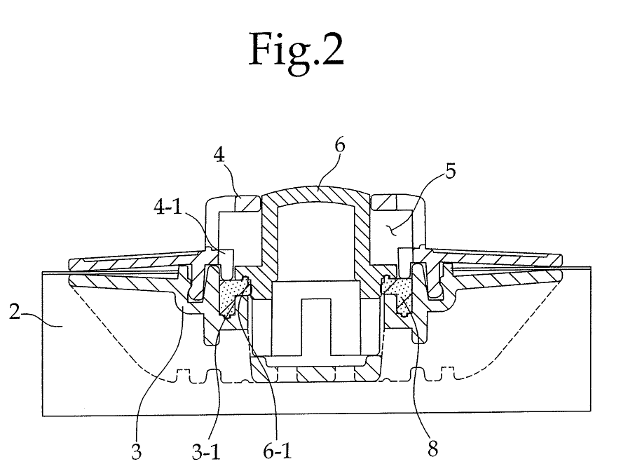

### DESCRIPTION OF THE PREFERRED EMBODIMENTS

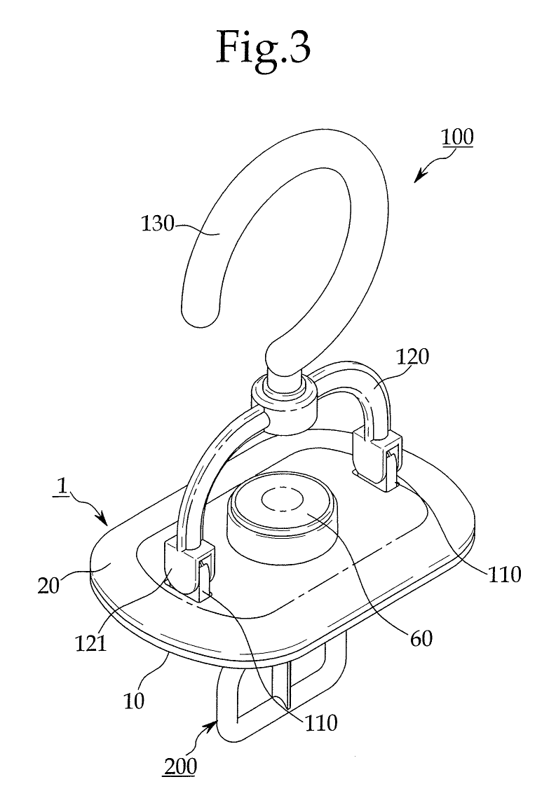

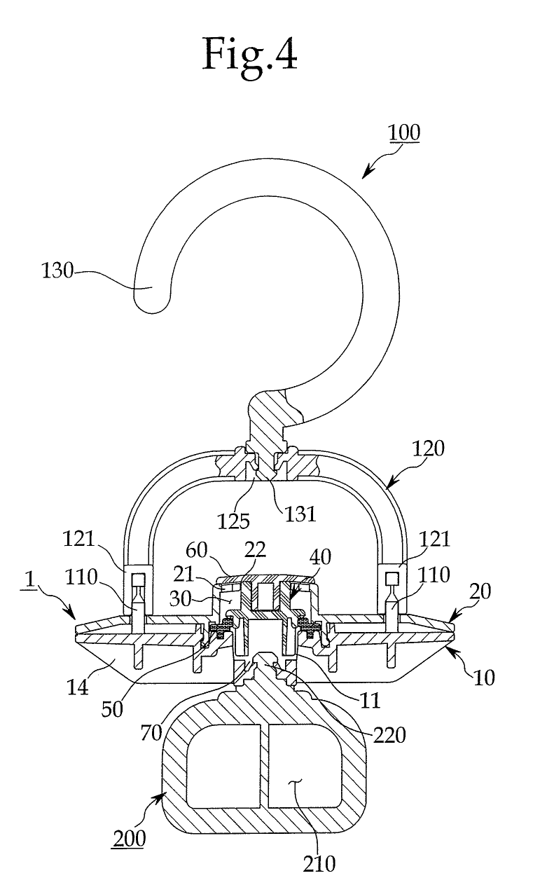

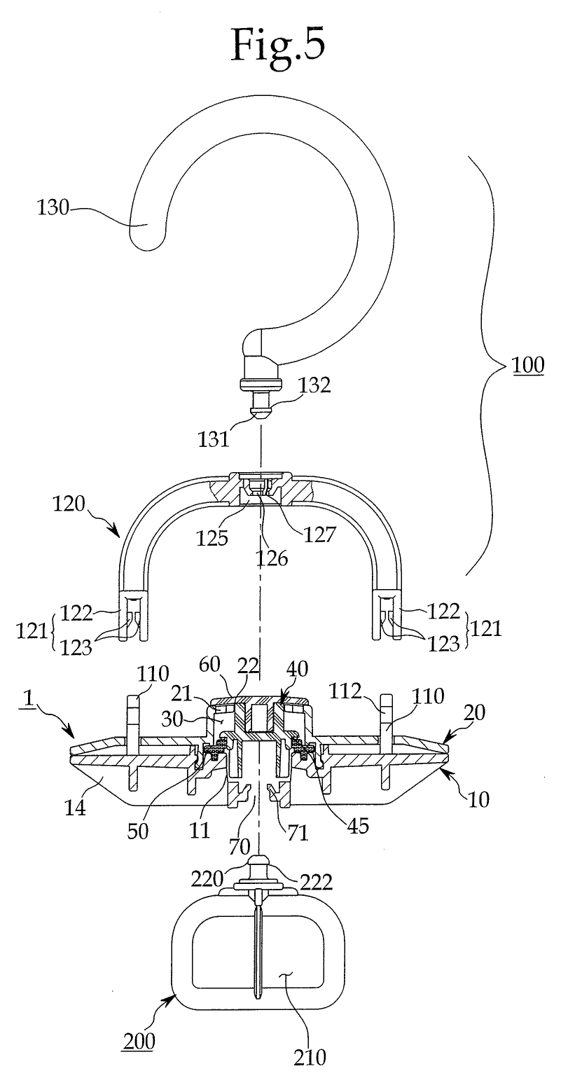

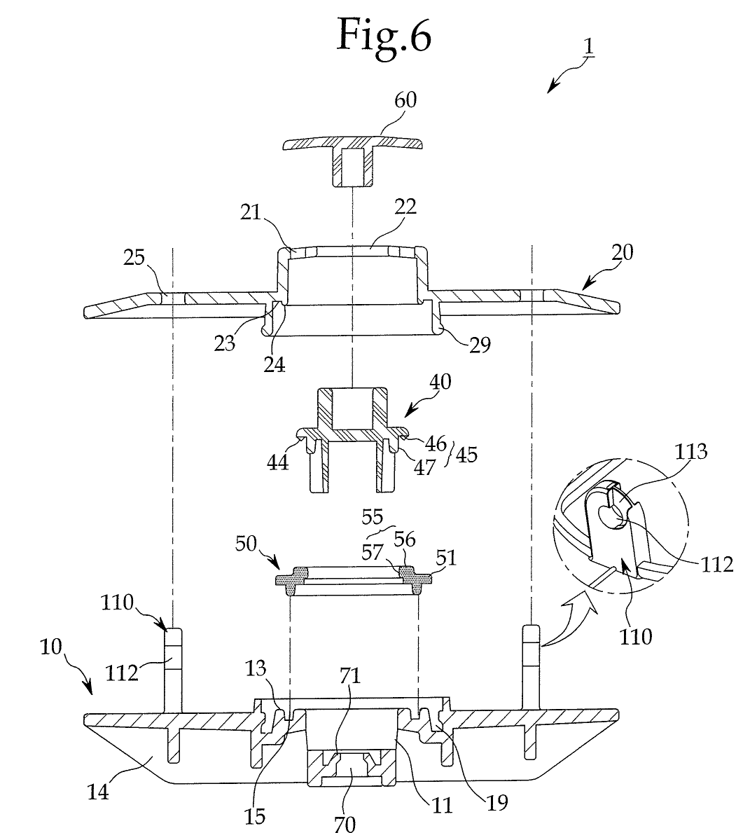

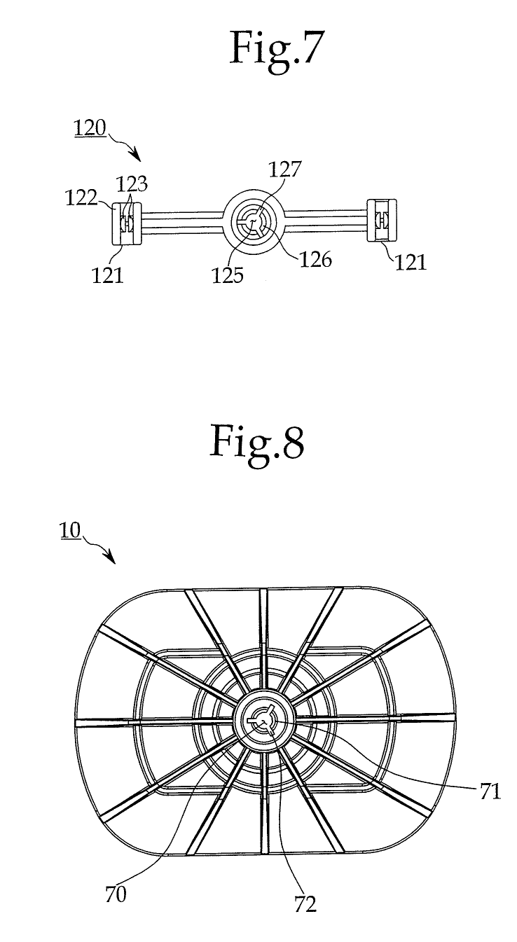

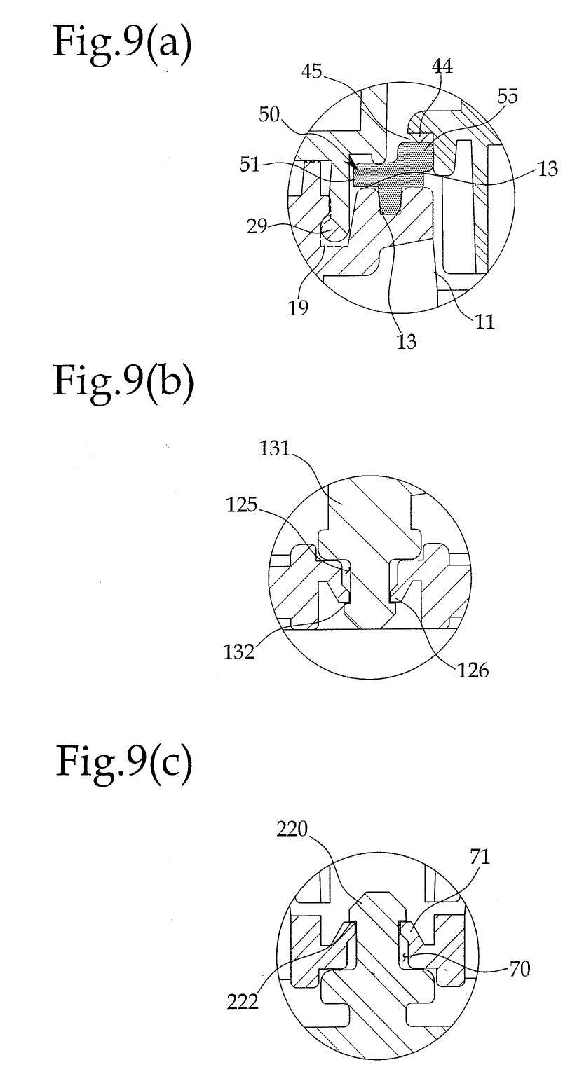

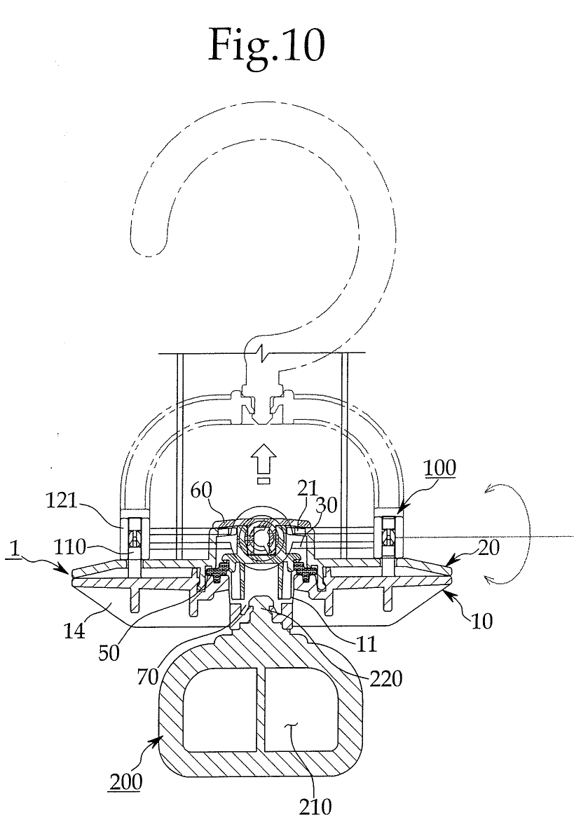

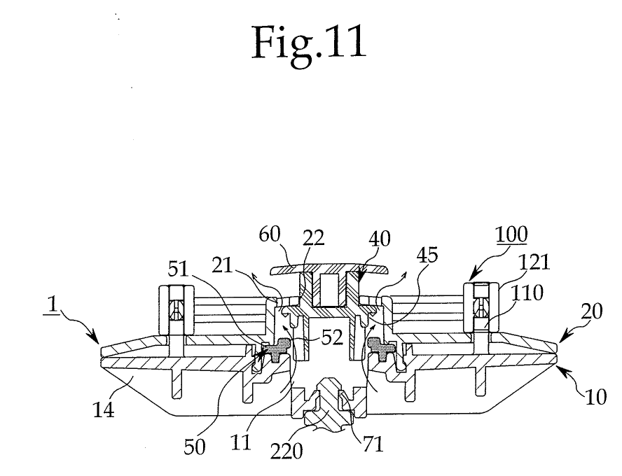

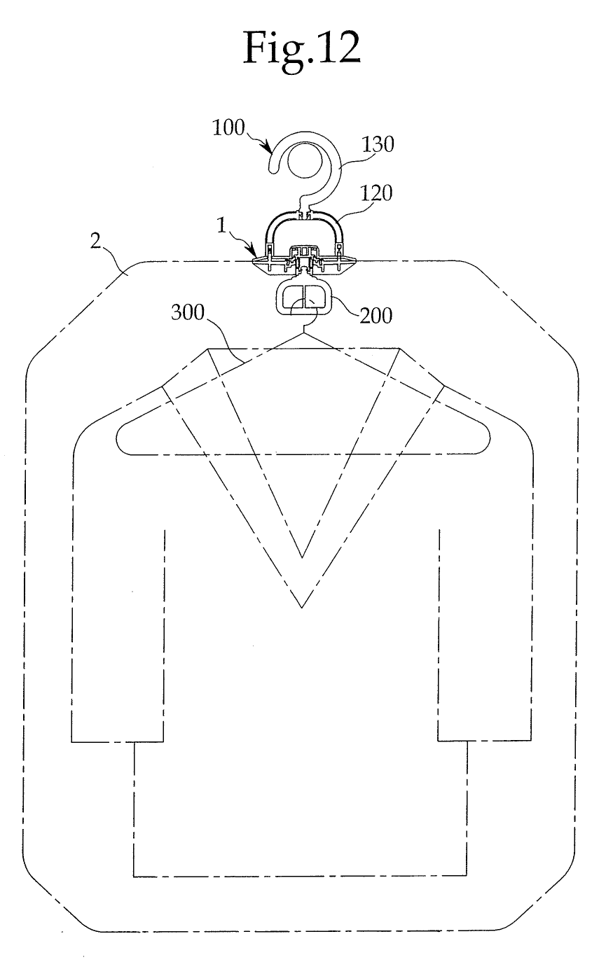

Hereinafter, the preferred embodiment of the present invention will be described with reference to FIGS. 3 to 12.

An air discharge valve assembly for a clothing compressing-and-storing bag according to the present invention is constructed so that a main body 10 having on its center an air passage 11 and a cover 20 having on its center a guide hole 22 and an air passage 21 are mounted to the upper and lower portions of a vacuum storage bag 2, and a lever 40 is inserted into an internal space 30 between the main body 10 and the cover 20 and moved up and down to be in close contact with a packing 50 installed between the main body 10 and the cover 20, thus opening or closing the air passage.

A packing-receiving groove 15 is circumferentially formed outside the upper portion of the air passage 11 of the main body 10 so that the packing 50 having on its upper portion contact parts 51 and 55 which protrude outwards and inwards is inserted into the packing-receiving groove 15.

The upper and lower portions of the outer contact part 51 of the packing 50 are in close contact with the lower support surface 23 of the cover 20 and the upper support surface 13 of the main body 10. A horizontal support surface 56 and a vertical support surface 57 provided on the upper portion and the inside portion of the inner contact part 55 are in close contact with the horizontal contact surface 46 and the vertical contact surface 47 of a stepped contact groove 45 formed along the circumference of the lower portion of the lever 40.

Here, circumferential pressure protrusions 24 and 44 protrude downwards from the lower support surface 23 of the cover 20 and the horizontal contact surface 46 of the lever 40, respectively, to be pressed against the contact parts 51 and 55 of the packing 50.

A plug 60 for closing the guide hole 22 and the air passage 21 formed in the center of the cover 20 is mounted to the upper portion of the lever 40.

According to this invention, the air discharge valve assembly further includes a hanger assembly 100. The hanger assembly 100 is used to hang and store the clothing compressing-and-storing bag in the form of a coat hanger and includes hanger support parts 110, a hanger body 120 and a hanger hook 130. The hanger support parts 110 each having an assembly hole 112 are provided on the opposite sides of the upper portion of the main body 10 in such a way as to protrude upwards. The hanger body 120 has on opposite sides assembly parts 121 which are elastically fitted over the corresponding hanger support parts 110 in such a way as to rotate forwards and backwards. The hanger hook 130 has an insert rod 131 which is rotatably inserted into an assembly hole 125 formed in the center of the upper portion of the hanger body 120.

A groove 113 is formed in each hanger support part 110 of the main body 10 to have a small thickness along part of the outer circumference of the upper portion of the assembly hole 112.

Each assembly part 121 of the hanger body 120 includes a “U”-shaped body 122 and locking pieces 123 which are provided on the opposite sides of the body 122 and elastically inserted into the assembly hole 112 of each hanger support part 110, thus preventing the hanger body 120 from being removed from the hanger support parts 110.

A locking step 132 is provided on the insert rod 131 which is provided on the lower end of the hanger hook 130. An elastic support part 126 is provided in the assembly hole 125 of the hanger body 120 and divided by a plurality of division grooves 127 which are arranged along the circumference of the assembly hole 125, thus preventing the locking step 132 of the insert rod 131 from being removed from the assembly hole 125.

Further, an assembly hole 70 is formed in the center of the lower portion of the main body 10 of the air discharge valve 1 so that an insert rod 220 provided on the upper portion of a hanger holding unit 200 having hanger holding holes 210 is rotatably inserted into the assembly hole 70.

A locking step 222 is provided on the insert rod 220. An elastic support part 71 is provided in the assembly hole 70 of the main body 10 and divided by a plurality of division grooves 72 which are arranged along the circumference of the assembly hole 70, thus preventing the locking step 222 of the insert rod 220 from being removed from the assembly hole 70.

Reference numeral 14 denotes a rib of the main body 10, reference numeral 19 denotes a coupling groove formed on the main body 10 to receive a coupling protrusion 29 of the cover 20, and reference numeral 25 denotes insert holes.

The operation of the present invention constructed as described above will be described below.

According to the present invention, after clothing or a similar item is put into the compressing-and-storing bag 2, the bag 2 is closed.

At this time, the clothing hung on an additional coat hanger 300 is put into the compressing-and-storing bag 2. The coat hanger 300 is inserted into and supported by the hanger holding holes 210 of the hanger holding unit 200 which is fitted into the lower assembly hole 70 of the air discharge valve 1.

Such a construction prevents the clothing from leaning to one side and allows the clothing to be neatly stored when the compressing-and-storing bag 2 is hung and stored in the fashion of a coat hanger.

In this way, a plurality of garments is put into and stored in the compressing-and-storing bag 2.

In such a state, air is discharged from the compressing-and-storing bag 2, so that the volume in the compressing-and-storing bag 2 is minimized and thus the clothing in the compressing-and-storing bag 2 is effectively stored.

First, the hanger body 120 of the hanger assembly 100 coupled to the upper portion of the air discharge valve 1 is rotated downwards around the hanger support parts 110 of the main body 10.

Here, the locking pieces 123 of the assembly parts 121 provided on both sides of the hanger body 120 are rotatably inserted into and supported to the assembly holes 112 of the hanger support parts 110.

Thereafter, after a suction nozzle of a vacuum cleaner or the like comes into close contact with the upper portion of the cover 20 of the air discharge valve 1, a suction operation is performed. Thereby, the opening operation of pulling the lever 40 upwards is conducted.

When the lever 40 is pulled up as such, the plug 60 coupled to the upper portion of the lever 40 is moved up, the upper air passage 12 of the cover 20 is opened. Further, the horizontal and vertical contact surfaces 46 and 47 formed in the contact groove 45 of the lever 40 are moved away from the horizontal and vertical support surfaces 56 and 57 formed in the inner contact part 55 of the packing 50, so that the air passage 11 is opened.

In this way, the air passage 11 of the main body 10 and the air passage 21 of the cover 20 are opened, so that air in the bag 2 is drawn and discharged sequentially through the lower air passage 11, the internal space 30 and the upper air passage 21.

At this time, the outer contact part 51 of the packing 50 is pressed and supported between the support surface 13 of the main body 10 and the support surface 23 of the cover 20, so that firm assembly is realized and a support protrusion protruding into a space to support the packing is not required unlike the prior art, and thus the element obstructing the flow of air is eliminated. Thereby, the operation of drawing and discharging the air is smoothly performed.

When the air is completely discharged from the bag 2, so that the compression is completed, the suction nozzle of the vacuum cleaner is removed from the upper portion of the cover 20.

As such, when the suction nozzle has been removed, the suction force through the suction nozzle is eliminated. At this time, due to the difference between internal and external pressures, the lever 40 moves downwards and returns to its original position. Thereby, the closing operation is performed.

That is, the horizontal and vertical contact surfaces 46 and 47 provided on the contact groove 45 of the lever 40 are in close contact with the horizontal and vertical support surfaces 56 and 57 formed in the inner contact part 55 of the packing 50 in horizontal and vertical directions, thus providing an airtight sealing operation.

Particularly, the pressure protrusion 44 protruding downwards from the horizontal contact surface 46 of the lever 40 presses the horizontal support surface 56 of the packing 50, thus achieving a more excellent airtight sealing operation.

Further, as the sealing operation is performed by the downward movement of the lever 40, the plug 60 moves downwards and returns to its original position, thus closing the upper portion of the cover 20. Thus, the guide hole 22 and the air passage 21 of the cover 20 are closed, thus preventing foreign materials and moisture from entering the bag 2, in addition to achieving more excellent sealing.

In this way, when the compression of the compressing-and-storing bag 2 has been completed, the hanger body 120 of the hanger assembly 100 coupled to the upper portion of the main body 10 of the air discharge valve 1 is rotated upwards and returns to its original position.

In such a state, using the hanger hook 130 coupled to the upper portion of the hanger body 120, the bag 2 is conveniently hung in a wardrobe or other space for storing clothing in a manner similar to that of hanging a coat hanger.

At this time, as described above, while the clothing stored in the compressing-and-storing bag 2 is hung on the additional coat hanger 300, it is hung on and supported by the hanger holding hole 210 of the hanger holding unit 200 which is assembled with the air discharge valve 1. Thus, during storage, the clothing does not lean to one side and is neatly stored.

Meanwhile, the hanger assembly 100 of the present invention is conveniently connected to the air discharge valve 1. That is, the assembly parts 121 provided on both sides of the hanger body 120 are inserted into the assembly holes 112 of the hanger support parts 110 protruding upwards from both sides of the main body 10 of the air discharge valve 1.

Each assembly part 121 of the hanger body 120 has the “U”-shaped body 122 and the locking pieces 123 provided on the opposite sides of the body 122. The locking pieces 123 are elastically inserted into the corresponding assembly holes 112 of the hanger support parts 110, so that the removal of the hanger body 120 from the air discharge valve 1 is prevented.

Particularly, the assembly parts 121 of the hanger body 120 are conveniently fitted into the assembly holes 112 of the hanger support parts 110 along the grooves 113, each of which has a small thickness and is formed along a predetermined portion of the upper circumference of each assembly hole 112.

The insert rod 131 of the hanger hook 130 is rotatably inserted into the assembly hole 125 which is formed in the center of the upper portion of the hanger body 120.

Here, the locking step 132 provided on the insert rod 131 of the hanger hook 130 is elastically supported by the elastic support part 126 which is formed in the assembly hole 125 of the hanger body 120.

Further, the insert rod 220 provided on the upper portion of the hanger holding unit 200 is rotatably inserted into the assembly hole 70 which is formed in the center of the lower portion of the main body 10 of the air discharge valve 1.

Here, the locking step 222 which is provided on the insert rod 220 of the hanger holding unit 200 is elastically supported by the elastic support part 71 which is formed in the assembly hole 70 of the main body 10.

Thus, the hanger assembly 100 and the hanger holding unit 200 of the present invention are conveniently mounted to the upper and lower portions of the air discharge valve 1, respectively.

As described above, the present invention provides an air discharge valve assembly for a clothing compressing-and-storing bag which improves the assembly structure of a main body, a cover, a lever and a packing, thus allowing air to be smoothly discharged from the compression-and-storing bag and effectively preventing the entry of external air into the bag by virtue of being air-tight, therefore improving the efficiency of use, and efficiently preventing the entry of moisture or mold into the bag. Further, the present invention allows a plurality of garments to be effectively stored in the compression-and-storing bag by hanging the garments in the form of being hung on a coat hanger, and allows the compression-and-storing bag itself to be conveniently stored by hanging it in the form of a coat hanger.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. An air discharge valve assembly for a clothing compressing-and-storing bag constructed so that a main body having on a center thereof an air passage and a cover having on a center thereof a guide hole and an air passage are mounted to upper and lower portions of a vacuum storage bag, and a lever is inserted into an internal space between the main body and the cover and moved up and down to be in close contact with a packing installed between the main body and the cover, thus opening or closing the air passage, wherein
a packing-receiving groove is circumferentially formed outside an upper portion of the air passage of the main body so that the packing having on an upper portion thereof contact parts which protrude inwards and outwards is inserted into the packing-receiving groove, and
upper and lower portions of an outer contact part of the packing are in close contact with a lower support surface of the cover and an upper support surface of the main body, and a horizontal support surface and a vertical support surface provided on an upper portion and an inside portion of an inner contact part are in close contact with a horizontal contact surface and a vertical contact surface of a stepped contact groove formed along a circumference of a lower portion of the lever.

2. The air discharge valve assembly as set forth in claim 1, further comprising a hanger assembly used to hang and store the clothing compressing-and-storing bag in a form of a coat hanger and including:
hanger support parts provided on opposite sides of an upper portion of the main body in such a way as to protrude upwards, each of hanger support parts having an assembly hole;
a hanger body having on opposite sides thereof assembly parts which are elastically fitted over the corresponding hanger support parts in such a way as to rotate forwards and backwards; and
a hanger hook having an insert rod which is rotatably inserted into an assembly hole formed in a center of an upper portion of the hanger body.

3. An air discharge valve assembly for a clothing compressing-and-storing bag constructed so that a main body having on a center thereof an air passage and a cover having on a center thereof a guide hole and an air passage are mounted to upper and lower portions of a vacuum storage bag, and a lever is inserted into an internal space between the main body and the cover and moved up and down to be in close contact with a packing installed between the main body and the cover, thus opening or closing the air passage, the air discharge valve assembly further comprising:
a hanger assembly used to hang and store the clothing compressing-and-storing bag in a form of a coat hanger and including:
hanger support parts provided on opposite sides of an upper portion of the main body in such a way as to protrude upwards, each of hanger support parts having an assembly hole;
a hanger body having on opposite sides thereof assembly parts which are elastically fitted over the corresponding hanger support parts in such a way as to rotate forwards and backwards; and
a hanger hook having an insert rod which is rotatably inserted into an assembly hole formed in a center of an upper portion of the hanger body.

4. The air discharge valve assembly as set forth in claim 2, wherein a groove is formed in each of the hanger support parts of the main body to have a small thickness along part of an outer circumference of an upper portion of the assembly hole, and each of the assembly parts of the hanger body comprises a “U”-shaped body and locking pieces which are provided on opposite sides of the body and elastically inserted into the assembly hole of each of the hanger support parts, thus preventing removal of the hanger body from the hanger support parts.

5. The air discharge valve assembly as set forth in claim 2, wherein a locking step is provided on the insert rod which is provided on a lower end of the hanger hook, and an elastic support part is provided in the assembly hole of the hanger body and divided by a plurality of division grooves which are arranged along a circumference of the assembly hole, thus preventing the locking step of the insert rod from being removed from the assembly hole.

6. The air discharge valve assembly as set forth in claim 2, wherein an assembly hole is formed in a center of a lower portion of the main body so that an insert rod provided on an upper portion of a hanger holding unit having a hanger holding hole is rotatably inserted into the assembly hole, and
a locking step is provided on the insert rod, and an elastic support part is provided in the assembly hole of the main body and divided by a plurality of division grooves which are arranged along a circumference of the assembly hole, thus preventing the locking step of the insert rod from being removed from the assembly hole.
